(19) United States
(12) Patent Application Publication
(10) Pub. No.: US 2026/0201977 A1
(43) Pub. Date: Jul. 16, 2026

(54) METHOD FOR RECOGNIZING A VALVE MODEL OF A VALVE AND VALVE ARRANGEMENT PROVIDED FOR CARRYING OUT THE METHOD

(71) Applicant: DANFOSS A/S, Nordborg (DK)

(72) Inventors: Kasper JEPSEN, Nordborg (DK); David Thaagaard KJAER, Nordborg (DK); Daniel B. NIELSEN, Nordborg (DK)

(21) Appl. No.: 19/129,865

(22) PCT Filed: Nov. 20, 2023
(86) PCT No.: PCT/EP2023/082399

§ 371 Date: May 14, 2025

(30) Foreign Application Priority Data
Nov. 21, 2022 (DK) PA202201065

(51) Int. Cl. F16K 37/00; F16K 31/04

(52) U.S. Cl. CPC F16K 37/0041; F16K 31/047

(57) ABSTRACT

The present inventions pertains to a method for recognizing a valve model of a valve connected to an actuator with a valve controller, the valve comprising a valve element for closing and opening a valve passage, wherein the valve element is in permanent contact with a non-translated spindle via threaded portions, wherein the spindle is provided for transmitting only rotational movement between the actuator and the valve element for generating a relative movement between the valve element and the spindle during the opening and closing of the valve, wherein the method recognizes the model of valve by the maximum allowable valve element stroke The invention also pertains to a valve arrangement comprising a valve and an actuator with a valve controller, the valve comprising a valve element for closing and opening a valve passage. The valve arrangement is provided for carrying out the previously described method.

### CROSS REFERENCE TO RELATED APPLICATION

This application is a national stage application under 35 U.S.C. § 371 of PCT Application No. PCT/EP2023/082399 filed Nov. 20, 2023, which claims priority to and the benefit of Danish Patent Application No. PA202201065 filed Nov. 21, 2022, the disclosure of each of which are incorporated herein by reference.

### BACKGROUND OF THE INVENTION

The disclosure pertains to a method for recognizing a valve model of a valve connected to an actuator with a valve controller, the valve may comprise a valve element for closing and opening a valve passage, wherein the valve element is in permanent contact with a non-translated spindle via threaded portions, wherein the spindle is provided for transmitting only rotational movement between the actuator and the valve element for generating a relative movement between the valve element and the spindle during the opening and closing of the valve, wherein the method recognizes the model of valve by the maximum allowable valve element stroke and may comprise the steps of:
moving the valve element to a first endpoint and a second endpoint of the valve element stroke by moving the valve element and the spindle relative to each other,
the valve controller determining the first endpoint of the valve element stroke as a closed position of the valve, in which the valve element closes the valve passage and a first blocking of the actuator is detected by the valve controller,
the valve controller determining the second endpoint of the valve element stroke as an open position of the valve, in which the valve element contacts an abutment of the valve or the actuator and a second blocking of the actuator is detected by the valve controller,
the valve controller determining a value representative of the maximum allowable valve element stroke and therefore of the model of valve, that is, a value representative of the distance between the first endpoint and the second endpoint of the valve element stroke from the total movement of the actuator between the two endpoints, and
outputting the value representative of the model of valve and thereby recognizing the valve model.

The disclosure also pertains to a valve arrangement that may comprise a valve and an actuator with a valve controller, the valve may comprise a valve element for closing and opening a valve passage. The valve arrangement is provided for carrying out the previously described method.

Actuator operated valves are used for controlling fluid flows in various operations. In order to ensure the correct functioning of the valve, it is important that a controller controlling the actuator has sufficient information on the model of the valve operated by the actuator. The correct information must be provided to the controller. Otherwise, the correct functioning of the valve cannot be ensured.

Document EP 3 403 012 B1 discloses a method for recognizing the model of a valve and an actuator for controlling movement of a valve, which is provided for recognizing the model of the valve. According to document EP 3 403 012 B1, a laterally displaceable spindle translates actuator movement to a valve rod. The model of the valve is determined based on the displacement of the spindle between a fully closed position of the valve, in which the spindle and the valve rod are connected to each other and another position of the spindle. Different models of valves are determined based on the different sizes of the valve rods or valves, which allow for different displacements of the spindle.

The method and device disclosed in this document are therefore not capable of recognizing valve models, which rely on non-displaceable, rotatory spindles. Such rotatory spindles are not displaced between two definable end positions. Rather, rotary spindles rotate while remaining at the same position.

### SUMMARY OF THE INVENTION

One aspect of the disclosure is to overcome this problem and to provide an improved method and device, which can determine the valve model of an actuator operated valve with a rotatory spindle for transferring a moment between the actuator and a valve element. This aim is reached by aspects of the disclosed method and aspects of the disclosed valve arrangement. Preferable embodiments are subject to the dependent claims.

According to aspects of the disclosure, a method for recognizing a valve model of a valve connected to an actuator with a valve controller is provided. The valve may comprise a valve element for closing and opening a valve passage, wherein the valve element is in permanent contact with a non-translated spindle via threaded portions, wherein the spindle is provided for transmitting only rotational movement between the actuator and the valve element for generating a relative movement between the valve element and the spindle during the opening and closing of the valve, wherein the method recognizes the model of valve by the maximum allowable valve element stroke and comprises the steps of:
moving the valve element to a first endpoint and a second endpoint of the valve element stroke by moving the valve element and the spindle relative to each other,
the valve controller determining the first endpoint of the valve element stroke as a closed position of the valve, in which the valve element closes the valve passage and a first blocking of the actuator is detected by the valve controller,
the valve controller determining the second endpoint of the valve element stroke as an open position of the valve, in which the valve element contacts an abutment of the valve or the actuator and a second blocking of the actuator is detected by the valve controller,
the valve controller determining a value representative of the maximum allowable valve element stroke and therefore of the model of valve, that is, a value representative of the distance between the first endpoint and the second endpoint of the valve element stroke from the total movement of the actuator between the two endpoints, and
outputting the value representative of the model of valve and thereby recognizing the valve model.

The permanent contact between the valve element and the non-translated spindle does not occur over the same constant contact surface. Rather, the valve element and the spindle maintain a threaded connection during their movement relative to each other.

The valve controller may be connected to an encoder for providing information on the actuator. The valve controller may be used in a subsystem, e.g., a control loop, which controls the mechanical movement of the actuator. The valve controller determines misalignment of the electrical position and the mechanical position of the actuator, which is used to determine when the valve element is being blocked at either endpoint. The valve controller may be a PCB with electronics hardware and/or software that can evaluate the signals and participate in the determination of the valve model.

The term valve controller may therefore be understood in a broad sense and may comprise further controller components connected to the valve controller. The valve controller may be provided in close contact to a stator of the actuator and opposite the spindle.

In order to determine which valve model or valve system is connected to the actuator, the actuator, e.g., a stepper motor, may be turned until it is blocked at two extreme endpoints. Prior to the determination of the valve model, a qualifying function can be performed automatically, which tries moving the valve element in either direction to check if the valve element is blocked. The spindle connected to the actuator permanently remains at the same position and moves the valve element between said two extreme endpoints. The endpoints are found when the valve controller no longer detects that the actuator is mechanically turning.

One of these endpoints may be set as a “zero point”. The actuator may turn the spindle in one direction, until the valve element closes the valve in a fully closed state of the valve and the spindle can no longer be turned. Thus, a first endpoint may be determined. Then the actuator may then turn in the opposite direction until the valve is fully open and the spindle can no longer be turned. This second endpoint is also found when the valve controller detects that the actuator is no longer mechanically turning. The number of electronic steps taken between these two endpoints is determined. The electronic steps corresponds to the number of pulses provided to the actuator, e.g., a stepper motor. The mechanical movement is reflected by the valve controller. The number of electronic steps corresponds to the maximum possible valve stroke. It is indicative of the size of the valve element and therefore of the valve model. The valve model can be found from a list including the number of steps from fully open to fully closed positions of the valve. The valve model can be found searching the list for the closest match, that is equal to or smaller than the found number of determined electronic steps, as the valve will never have less steps than rated. The searched list provides an index number referring to the valve model connected, wherein the index number is also referenced to the number of electronic steps determined by the valve controller.

In other aspects, the valve element may comprise an internal threaded portion for permanently contacting an external thread portion of the non-translated spindle. The valve element may be guided within the valve such that it is prevented from rotating together with the spindle. Upon rotation of the spindle, the valve element is translated between an open and closed position of the valve.

In other aspects, the spindle is at least partially inserted into the valve element at all positions of the valve. The threaded coupling between the spindle and the valve element requires at least some contact between the threaded portions of the spindle and the valve element at all valve positions.

In other aspects, the spindle is furthest inserted into the valve element at the fully open position of the valve and least inserted into the valve element at the closed position of the valve. In alternative aspects, the spindle may be furthest inserted into the valve element in a fully closed position of the valve. The axial movement of the valve element may be limited by some neighbouring structures such as a valve seat in the fully closed position of the valve and the abutment in the fully open position of the valve.

In other aspects, the spindle may fully penetrate at least the threaded portion of the valve element for reaching the fully open position of the valve. The valve element may comprise a corresponding threaded through hole, which allows for its penetration. As the components of the valve, i.e. the spindle and the valve element can be moved into each other during the operation of the valve, the valve size can be kept to a minimum.

In other aspects, different models of valve elements have different lengths in an axial direction of the valve. The different lengths of the valve elements provide a simple way of distinguishing different models of valve elements and therefore different models of valves. The different valve elements may abut the same features of the valve, e.g., the valve seat and the abutment, at the endpoints of the valve element's stroke.

In other aspects, the spindle may be magnetically coupled to a rotor of the actuator. The rotor of the actuator and the spindle may be connected via a magnetic coupling and rotate together for moving the valve element.

In other aspects, the abutment is provided at a connection portion connecting the actuator to the valve. The connection portion may be situated opposite a valve seat and may comprise any components linking the valve to the actuator.

The disclosure is also directed at a valve arrangement that may comprise a valve and an actuator with a valve controller, the valve may comprise a valve element for closing and opening a valve passage. The valve arrangement is provided for carrying out the presently described method.

These aspects of the disclosure may be combined in any suitable manner. Further details and advantages are described with reference to the Figures.

### BRIEF DESCRIPTION OF THE DRAWINGS

FIG. 1 is a sectional view of a valve arrangement according to aspects of the disclosure; and

FIG. 2 is a flow diagram of a method for recognizing a valve model according to aspects of the disclosure.

### DETAILED DESCRIPTION

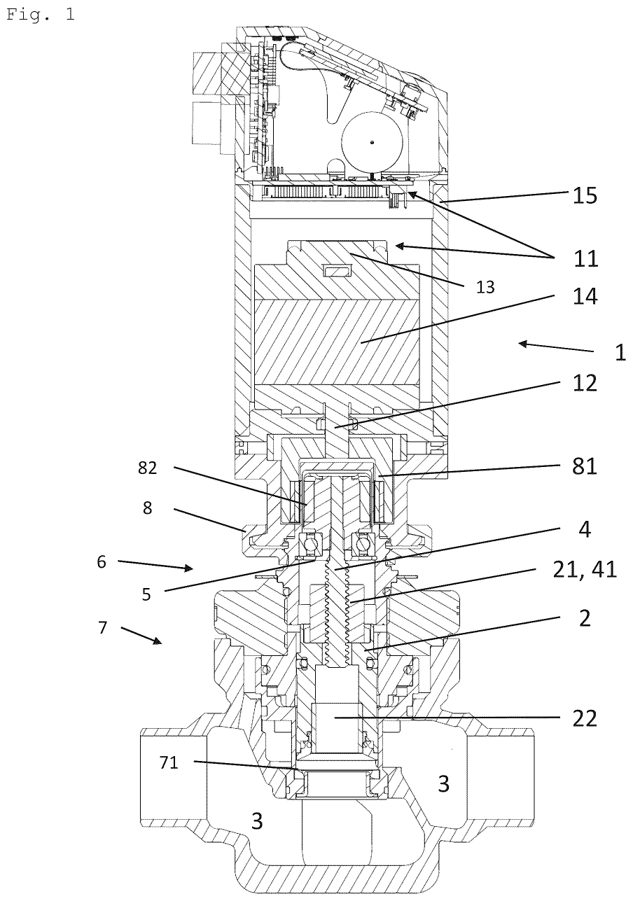

With reference to FIG. 1, aspects of the valve arrangement as shown. The valve arrangement may comprise a valve 7, which is connected to an actuator 1 with a valve controller 11. The valve 7 may comprise any components required for varying the fluid flow through the valve 7, such as a valve element 2 for closing and opening a valve passage 3. The valve element 2 may be in permanent contact with a spindle 4 that is non-translated via threaded portions (e.g., an internal threaded portion 21 and an external threaded portion 41), wherein the spindle 4 is provided for transmitting only rotational movement between the actuator 1 and the valve element 2 for generating a relative translatory movement between the valve element 2 and the spindle 4 during the opening and closing of the valve 7. The disclosed method may recognize the model (or valve model) of the valve 7 by the maximum allowable valve element 2 stroke. The model of the valve 7 may therefore be dependent on the model of valve element 2 used. All or some other components of the valve 7, such as a valve housing, may be identical in different models of the valve 7.

The valve controller 11 may be connected to an encoder 13 for providing information on the actuator 1. The encoder may be provided as an integrated part of a motor 14 of the actuator 1. The valve controller 11 may be used in a subsystem, e.g., a control loop, which controls the mechanical movements of the actuator 1. The valve controller 11 determines misalignment of the electrical position and the mechanical position of the actuator 1, which is used to determine when the valve element 2 is being blocked at either endpoint. The mechanical position is reflected by the position determined by the valve controller 11 and the electrical position is determined by the number of pulses. The magnetic coupling between the actuator 1 and the spindle 4 is very rigid compared to the coupling between the motor rotor and the motor stator of the motor 14. This means that electrical pulses sent to the actuator 1 may not be converted into mechanical movement, because the valve element 2 is blocked or has reached an end position. The lack of movement may be detected by the valve controller 11. The actuator 1 may comprise the motor 14, the valve controller 11, the actuator housing 15 and/or at least some parts of a magnetic coupling (e.g., a external magnetic coupling 81 and an internal magnetic coupling 82).

The valve controller 11 may be understood in a broad sense and may comprise further controller components connected to the valve controller 11. The valve controller 11 may comprise a PCB and further electronic components, which may be placed in the upper part of the actuator 1. The valve controller 11 may be hard-wired to the encoder 13. The encoder 13 may be regarded as a part of the valve controller 11 and/or it may be physically and/or rigidly coupled to the motor rotor. Some or all components of the valve controller 11 may be arranged at a side of the motor 14 opposite the magnetic coupling (e.g., the external magnetic coupling 81 and the internal magnetic coupling 82). This arrangement of the valve controller 11 ensures that electronic components of the valve controller 11 are placed as far away as possible from the valve 7. The detrimental impact of varying temperatures of the valve 7 on the valve controller 11 may therefore be limited. The valve controller 11 may be placed fully or at least partially outside the actuator 1. In other aspects, the valve controller 11 may be provided in close contact to the motor stator of the actuator 1 and opposite the spindle 4.

To determine the model of the valve 7 or valve system is connected to the actuator 1, the actuator 1 (e.g., the motor 14 such as a stepper motor), may be turned until it is blocked at two extreme endpoints. Prior to the determination of the valve 7 model, a qualifying function can be performed automatically, which tries moving the valve element 2 in either direction to check if the valve element 2 is blocked. The spindle 4 connected to the actuator 1 permanently remains at the same position and moves the valve element 2 between said two extreme endpoints only through rotation of the spindle 4. The endpoints are found when the valve controller 11 no longer detects that the actuator 1 is mechanically turning. One of these endpoints may be set as a “zero point”.

The actuator 1 may turn the spindle 4 in one direction, until the valve element 2 closes the valve 7 in a fully closed state of the valve 7 and the spindle 4 can no longer be turned. Thus, a first endpoint may be determined. Then the actuator 1 may turn in the opposite direction until the valve 7 is fully open and the spindle 4 can no longer be turned. This second endpoint is also found when the valve controller 11 detects that the actuator 1 is no longer mechanically turning. The number of electronic steps taken between these two endpoints is determined. This number corresponds to the maximum possible valve stroke. It is indicative of the size of the valve element 2 and therefore of the model of the valve 7. The model of the valve 7 can be found from a list including the number of steps from fully open to fully closed positions of the valve 7. The valve 7 model can be found searching the list for the closest match, that is equal to or smaller than the found number of determined electronic steps, as the valve 7 will never have less steps than rated. The searched list provides an index number referring to the valve 7 model connected, wherein the index number is also referenced to the number of electronic steps determined by the valve controller 11.

The valve element 2 comprises an internal threaded portion 21 for permanently contacting an external threaded portion 41 of the non-translated spindle 4. The internal threaded portion 21 of the valve element 2 may extend over the entire length of a cylindrical through hole within the valve element 2. The through hole within the valve element 2 may be adjacent to a hollow cylindrical portion 22 within the valve element 2. The hollow cylindrical portion 22 of the valve element 2 may extend until the bottom most portion of the valve element 2 and may be close to a valve seat 71 in the closed position of the valve 7. The valve element 2 may be guided within the valve 7 such that it is prevented from rotating together with the spindle 4. A guiding portion may extend within the valve 7 in an axial direction for preventing the valve element 2 from rotating. Upon rotation of the spindle 4, the valve element 2 is translated between an open and the closed position of the valve 7 shown in FIG. 1.

The spindle 4 is at least partially inserted into the valve element 2 at all positions of the valve 7. The threaded coupling between the spindle 4 and the valve element 2 requires at least some contact between the threaded portions (e.g., the internal threaded portion 21 and the external threaded portion 41) of the spindle 4 and the valve element 2 at all positions of the valve 7.

The spindle 4 is furthest inserted into the valve element 2 at the fully open position of the valve 7 and least inserted into the valve element 2 at the closed position of the valve 7. In an alternative embodiment, the spindle 4 may be furthest inserted into the valve element 2 in a fully closed position of the valve 7. The axial movement of the valve element 2 may be limited by some neighbouring structures such as the valve seat 71 in the fully closed position of the valve 7 and the abutment 5 in the fully open position of the valve 7.

The spindle 4 may fully penetrate at least the internal threaded portion 21 of the valve element 2 for reaching the fully open position of the valve 7. The valve element 2 may comprise a corresponding threaded through hole, which allows for its penetration. As the components of the valve 7, i.e., the spindle 4 and the valve element 2 can be moved into each other during the operation of the valve 7, the valve 7 size can be kept to a minimum.

Different models of the valve element 2 and the spindle 4 may have different lengths in an axial direction of the valve 7. The axial direction of the valve 7 may correspond to the longitudinal direction of the spindle 4. The different lengths of different models of the valve element 2 and the spindle 4 provide a simple way of distinguishing different models of the valve element 2 and therefore different models of the valve 7. The different valve elements 2 may abut the same features of the valve 7, i.e., the valve seat 71 and a abutment 5, at the endpoints of the stroke of the valve element.

The spindle 4 is magnetically coupled to a rotor of the actuator 1. The rotor interacts with a stator of the actuator 1 for rotating the rotor. Both components are situated within the actuator housing 15 of the actuator 1. The rotor of the actuator 1 may be fixedly connected to an external magnetic coupling rotor 81 via a shaft 12. The external magnetic coupling rotor 81 may be aligned coaxially to and provided around an internal magnetic coupling rotor 82. The external and internal magnetic coupling rotors 81, 82 may be magnetically coupled to each other, such that they rotate together. The rotor of the actuator 1, the shaft 12 and the spindle 4 thus rotate together for moving the valve element 2 due to the strong magnetic coupling. The valve 7 therefore comprises elements, which exhibit rotational movement, and other elements, which exhibit only translatory movement during the opening and closing of the valve 7.

The abutment 5 is provided at a connection portion 6 connecting the actuator 1 to the valve 7. The connection portion 6 may be fixed to the actuator 1 via a clamp 8. The connection portion 6 may be situated opposite the valve seat 71 and may comprise any components linking the valve 7 to the actuator 1. Two possible positions for the abutment 5 are shown. In the upper one, the valve element 2 abuts a surface surrounding the upper end of a threaded part of the spindle 4. In the upper one, any radially inward pointing protrusion contactable by the valve element 2 may function as an abutment 5.

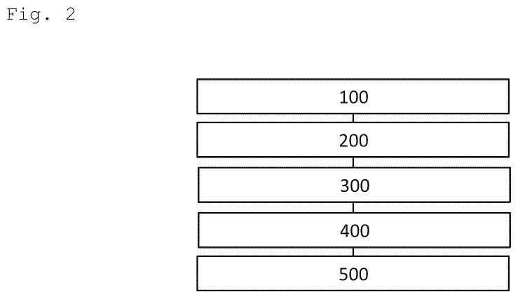

According to FIG. 2, the presently described method may comprise at least the following five the steps

Step 100 comprises moving the valve element 2 to a first and/or a second endpoint of the valve element 2 stroke by moving the valve element 2 and the spindle 4 relative to each other.

The two endpoints are detected by the valve controller 11. The valve controller 11 determines the first endpoint of the valve element 2 stroke in step 200 as a closed position of the valve 7, in which the valve element 2 closes the valve passage 3 and a first blocking of the actuator 1 is detected by the valve controller 11. The valve controller 11 does not need to differentiate between an open and a closed position of the valve 7, it may only recognize blocked states of the actuator 1.

The valve controller 11 determines the second endpoint of the valve element 2 stroke in step 300 as an open position of the valve 7, in which the valve element 2 contacts an abutment 5 of the valve 7 or the actuator 1 and a second blocking of the actuator 1 is detected by the valve controller 11.

It should be noted, that step 200 and step 300 may be carried out in reverse order. They may be carried out as part of step 100 or before and after step 100, i.e., the moving of the valve element 2 between the first and second endpoint according to step 100 may be carried out between the detection of the first endpoint and the second endpoint. If the valve element 2 is already at an endpoint at the start of the method, it may be not necessary to move the valve element 2 to this endpoint. Rather, this endpoint may be determined without movement of the valve element 2. The valve element 2 may therefore only need to be moved to the other endpoint in step 100 for determining the other endpoint.

In case the valve element 2 is at an intermediate position between the fully open and fully closed position of the valve 7 at the beginning of the method, step 100 may comprise moving the valve element 2 to one of the extreme positions of the valve 7, i.e., to the fully open or fully closed position, as a first movement of the valve element 2. Once the valve controller 11 has detected the blocking of the actuator 1, rotation can be reversed for the valve element 2 to reach the other extreme position of the valve 7.

In step 400, the valve controller 11 determines a value representative of the maximum allowable valve element 2 stroke and therefore of the model of the valve 7, that is, a value representative of the distance between the first endpoint and the second endpoint of the valve element 2 stroke from the total movement of the actuator 1 between the first end point and the second endpoint. This value may correspond to the number of electronic steps the actuator 1 took between the first endpoint and the second endpoint.

Finally, in step 500, the value representative of the model of the valve 7 is output and the valve 7 model is thereby recognized. The value representative of the model of the valve 7 may be looked up from a table in which values representative of the maximum allowable stroke of the valve element 2 are correlated to the model of the valve 7. The output may be a signal of any suitable model. A controller may interact with the valve controller 11 to effect all or some of the steps of the method.

1. A method for recognizing a valve model of a valve connected to an actuator with a valve controller, the valve comprising a valve element for closing and opening a valve passage, wherein the valve element is in permanent contact with a spindle that is non-translated via threaded portions, wherein the spindle is provided for transmitting only rotational movement between the actuator and the valve element for generating a relative movement between the valve element and the spindle during the opening and closing of the valve, wherein the method recognizes the valve model of the valve by a maximum allowable valve element stroke and comprising the steps of:
moving the valve element to a first endpoint and a second endpoint of the valve element stroke by moving the valve element and the spindle relative to each other;
determining with the valve controller the first endpoint of the valve element stroke as a fully closed position of the valve, in which the valve element closes the valve passage and a first blocking of the actuator is detected by the valve controller;
determining with the valve controller the second endpoint of the valve element stroke as an fully open position of the valve, in which the valve element contacts an abutment and a second blocking of the actuator is detected by the valve controller;
determining with the valve controller a value representative of the maximum allowable stroke of the valve element and therefore of the valve model of the valve, that is, a value representative of a distance between the first endpoint and the second endpoint of the valve element stroke from a total movement of the actuator between the first endpoint and the second endpoint; and
outputting the value representative of the valve model of the valve and thereby recognizing the valve model of the valve.

2. The method of claim 1, wherein the valve element comprises an internal threaded portion for permanently contacting an external threaded portion of the spindle.

3. The method of claim 1 wherein, the spindle is at least partially inserted into the valve element at all positions of the valve.

4. The method of claim 1 wherein, the spindle is furthest inserted into the valve element at the fully open position of the valve and least inserted into the valve element at the closed position of the valve.

5. The method of claim 1 wherein, the spindle fully penetrates at least one of the threaded portions of the valve element for reaching the fully open position of the valve.

6. The method of claim 1 wherein different models of valve elements have different lengths in an axial direction of the valve.

7. The method of claim 1 wherein the spindle is magnetically coupled to a rotor of the actuator.

8. The method of claim 1 wherein the abutment provided is located at a connection portion connecting the actuator to the valve.

9. The method of claim 1 further comprising the step of providing a valve arrangement comprising the valve and the actuator with the valve controller; and, the valve comprising the valve element for closing and opening the valve passage.

10. The method of claim 2 wherein the spindle is at least partially inserted into the valve element at all positions of the valve.

11. The method of claim 2 wherein the spindle is furthest inserted into the valve element at the fully open position of the valve and least inserted into the valve element at the closed position of the valve.

12. The method of claim 3 wherein the spindle is furthest inserted into the valve element at the fully open position of the valve and least inserted into the valve element at the closed position of the valve.

13. The method of claim 2 wherein the spindle fully penetrates at least one of the threaded portions of the valve element for reaching the fully open position of the valve.

14. The method of claim 3 wherein the spindle fully penetrates at least one of the threaded portions of the valve element for reaching the fully open position of the valve.

15. The method of claim 2 wherein the spindle is magnetically coupled to a rotor of the actuator.

16. The method of claim 3 wherein the spindle is magnetically coupled to a rotor of the actuator.

17. The method of claim 2 wherein the abutment is located at a connection portion connecting the actuator to the valve.

18. The method of claim 3 wherein the abutment is located at a connection portion connecting the actuator to the valve.

19. The method of claim 2 further comprising the step of providing a valve arrangement comprising the valve and the actuator with the valve controller; and the valve comprising the valve element for closing and opening the valve passage.

20. The method of claim 3 further comprising the step of providing a valve arrangement comprising the valve and the actuator with the valve controller; and the valve comprising the valve element for closing and opening the valve passage.
